(19) United States
(12) Patent Application Publication
(10) Pub. No.: US 2009/0077973 A1
(43) Pub. Date: Mar. 26, 2009

(54) Gas Turbine Fuel System for High Altitude Starting and Operation

(75) Inventors: Xiaolan Hu, San Diego, CA (US); Daih-Yeou Chen, San Diego, CA (US); Ricardo Cabra, San Diego, CA (US); David L. Ripley, San Diego, CA (US)

Correspondence Address: STEPHEN GEORGE MICAN, Post Office Box 803338, #8973, Chicago, IL, 60680-3338, US

(73) Assignee: HAMILTON SUNDSTRAND CORPORATION, Windsor Locks, CT (US)

(21) Appl. No.: 11/858,320

(22) Filed: Sep. 20, 2007

(51) Int. Cl. F02C 7/22; F23R 3/28

(52) U.S. Cl. 60/741; 60/746

(57) ABSTRACT

A fuel system for a gas turbine engine comprises a set of starting fuel injectors that operate in a fuel pressurised atomisation mode to atomise fuel that flows therethrough during an ignition and a post-ignition phase and a set of main fuel injectors that operate in an air blast mode to atomise fuel that flows therethrough during the post-ignition phase and a high altitude ready to load phase and an air assist mode to control the pattern of fuel atomisation during a loaded phase.

### FIELD OF THE INVENTION

The invention relates to fuel systems for gas turbine engines and more particularly to such fuel systems that for gas turbines that start and run at high altitudes.

### BACKGROUND OF THE INVENTION

Traditionally there are two types of fuel systems for high altitude starting and running of gas turbine engines. One system uses starting and main fuel injectors in the high-pressure atomisation mode, using a flow divider to regulate the start fuel pressure. The starting and main fuel injectors are either all duplex or a mix of duplex for starting and main fuel injectors and simplex for main fuel injectors. This fuel system requires a relatively high minimum fuel pressure to maintain fuel spray quality during engine starting and coking-free operation during engine operation. Under very high altitude conditions, total engine fuel flow may be very low, thereby promoting possible coking of the injectors. For systems with all duplex injectors, minimum fuel pressure requirements drive the number of fuel injectors to a very low count. This negatively affects combustion exit temperature pattern factor. For systems with a mix of duplex and simplex injectors, this will starve the fuel flow to the simplex injectors and cause injector coking.

Another system uses starting fuel injectors that operate in the pressure atomisation mode and main fuel injectors that operate in the air blast mode. The air blast mode uses pressurised air to induce atomisation of fuel that flows through the main fuel injectors. Again, a flow divider regulates the start fuel pressure. This system allows a smaller number of starting fuel injectors to maintain high fuel pressure for high altitude ignition. However, in order to provide power for engine starting, the air blast injectors need to turn on at low engine speed with very high air pressure drop to maintain good fuel atomisation. If the air pressure drop is too low, the engine may blow out or develop a torch in its tailpipe due to poor resulting fuel spray quality. Therefore, this system requires that the combustor and fuel injectors have a high degree of system level optimisation to achieve high altitude starting reliability. The combination of good atomisation with low airflow to insure low air pressure drop needed for high altitude starting reliability thus creates tough and expensive design requirements for this system.

### SUMMARY OF THE INVENTION

The invention generally comprises a fuel system for a gas turbine engine, comprising a set of starting fuel injectors that operate in a fuel pressurised atomisation mode to atomise fuel that flows through them during an ignition and a post-ignition phase and a set of main fuel injectors that operate in an air blast mode to atomise fuel that flows therethrough during the post-ignition and a high altitude ready to load phase and an air assist mode to control the pattern of fuel atomisation during a loaded phase.

### DESCRIPTION OF THE DRAWINGS

FIG. 1 is a schematic diagram of one type of fuel system for a gas turbine engine according to the prior art.

FIGS. 2 and 3 are schematic diagrams of another type of fuel system for a gas turbine engine according to the prior art.

FIGS. 4 and 5 are schematic diagrams of a fuel system for a gas turbine engine according to a first possible embodiment of the invention.

FIGS. 6, 7 and 8 are schematic diagrams of a fuel system for a gas turbine engine according to a second possible embodiment of the invention.

### DETAILED DESCRIPTION OF THE INVENTION

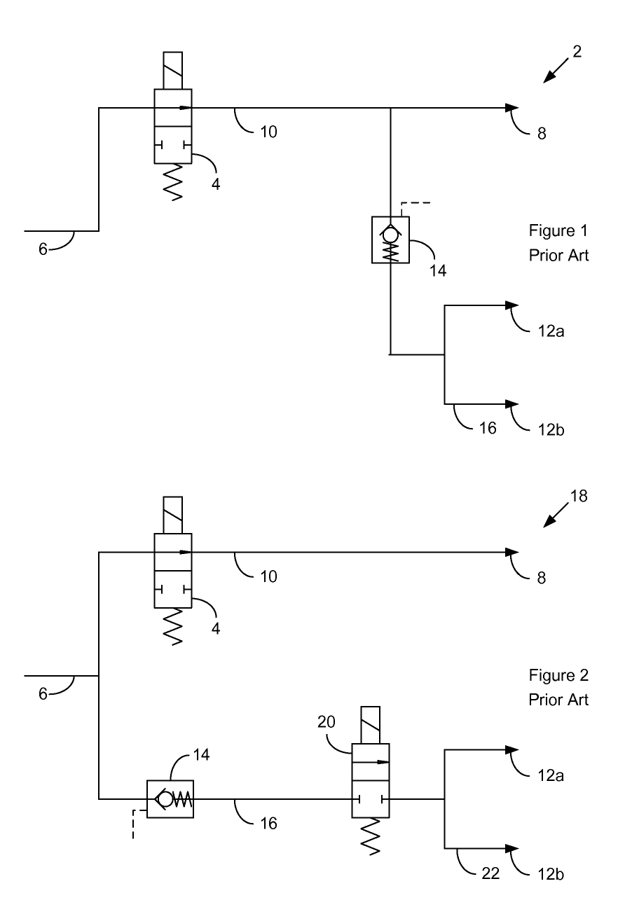

FIG. 1 is a schematic diagram of one type of fuel system 2 for a gas turbine engine according to the prior art. A fuel supply (not shown) supplies fuel to a starting solenoid 4 by way of a fuel supply line 6. The starting solenoid 4 opens, as shown, for ignition, post-ignition and running phases. The starting solenoid 4 supplies fuel to a plurality of starting fuel injectors 8 by way of a starting solenoid output line 10. The starting fuel injectors 8 may be duplex primaries of duplex fuel injectors, as shown, or simplex starting fuel injectors. The starting solenoid 4 also supplies fuel to a plurality of main fuel injectors 12 by way of a flow divider 14 and a flow divider output line 16. The main fuel injectors 12 may be any combination of duplex secondaries 12a and simplex main fuel injectors 12b, as shown, or all duplex fuel injectors. The starting fuel injectors 8 discharge pressure atomised fuel droplets for ignition and operate in a high-pressure fuel atomisation mode. During post-ignition, ready to load and loaded phases, the starting fuel injectors 8 continue to operate in the high pressure atomisation mode whilst there is sufficient fuel pressure so that the main fuel injectors 12a, 12b operate in the high pressure atomisation mode as well. A serious problem with this arrangement in high altitude environments is that for a duplex and simplex mix system, under low fuel flow conditions, due to flow divider regulation, the simplex fuel injectors will starve of fuel flow and cause them to suffer injector coking. For an all-duplex system, the number of injectors may have to be very low to meet minimum fuel pressure requirements, which will have adverse impact on combustor exit temperature pattern factor.

Alternatively, the main fuel injectors 12a, 12b may operate in the air blast mode. Reliable high altitude starting is difficult to implement with this arrangement. Furthermore, the air-blast main fuel injectors 12 need to provide fuel at low engine speed with enough air pressure drop to maintain adequate fuel atomisation. If the air pressure drop is too low, the engine will blow out or have a torch develop in its tailpipe due to poor fuel spray quality.

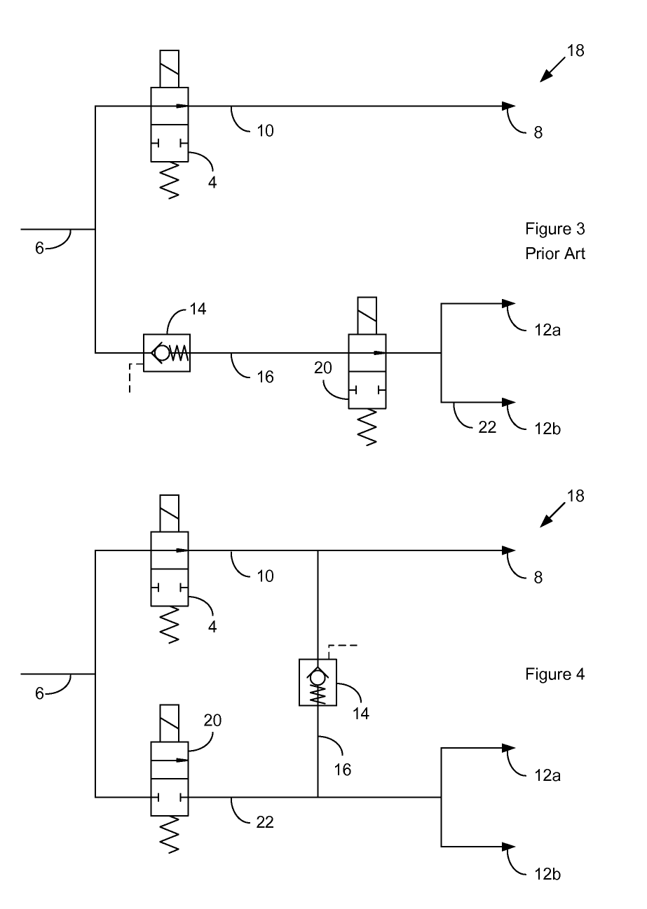

FIGS. 2 and 3 are schematic diagrams of another type of fuel system 18 for a gas turbine engine according to the prior art. The fuel supply again supplies fuel to the starting solenoid 4 by way of the fuel supply line 6 and the starting solenoid 4 supplies fuel to the plurality of starting fuel injectors 8 by way of the starting solenoid output line 10 as hereinbefore described in connection with the fuel system 2 shown in FIG. 1. The fuel supply also supplies fuel to the flow divider 14 by way of the fuel supply line 6. The flow divider 14 in turn supplies fuel to a main solenoid valve 20 by way of the flow divider output line 16. The main solenoid 18 supplies fuel to the main fuel injectors 12 by way of a main solenoid output line 22. During the ignition phase, the starting solenoid valve 4 opens and the main solenoid valve 20 remains shut as shown in FIG. 2. During the post-ignition, ready to load and loaded phases the starting solenoid valve 4 remains open and main solenoid valve 20 opens as shown in FIG. 3. The starting fuel injectors 8 operate in the high-pressure atomisation mode and the main fuel injectors 12 operate in the air blast mode. Reliable high altitude starting is difficult to implement with this arrangement. Furthermore, the air-blast main fuel injectors 12 need to provide fuel at low engine speed with enough air pressure drop to maintain adequate fuel atomisation. If the air pressure drop is too low, the engine will blow out or have a torch develop in its tailpipe due to poor fuel spray quality.

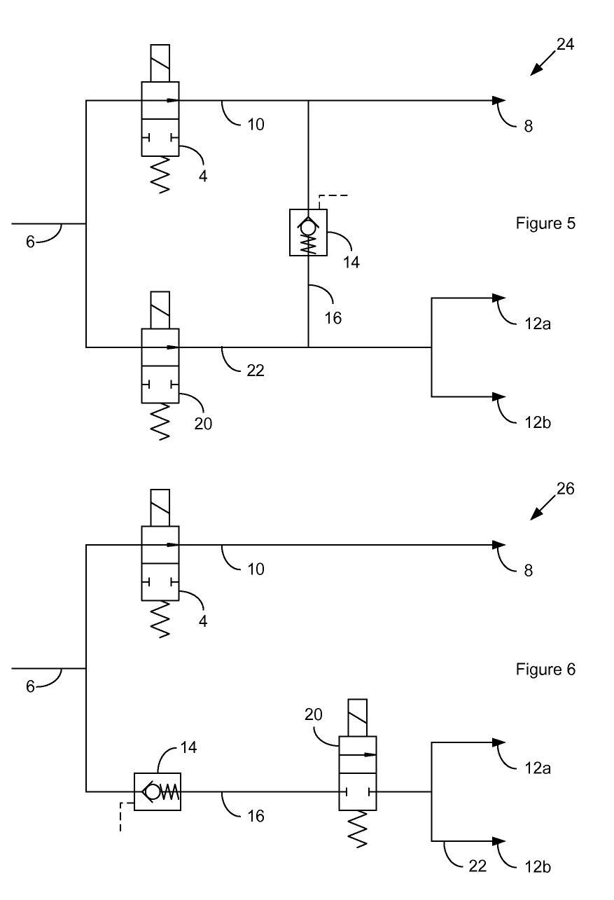

FIGS. 4 and 5 are schematic diagrams of a fuel system 24 according to one possible embodiment of the invention. The fuel supply supplies fuel to both the starting solenoid valve 4 and the main solenoid valve 20 by way of the fuel supply line 6. The starting solenoid 4 supplies fuel to the starting fuel injectors 8 and the flow divider 14 by way of the starting solenoid output line 10. The main solenoid valve 20 supplies fuel to the main fuel injectors 12 by way of the main solenoid output line 22. During the ignition and post-ignition phases, the starting solenoid valve 4 opens and the main solenoid valve 20 remains shut, as shown in FIG. 4. The flow divider 14 diverts flow from the start fuel injectors 8 to the main fuel injectors 12 by way of the flow divider output line 16 as necessary to control fuel system pressure during the post-ignition phase. The starting solenoid valve 4 remains open and the main solenoid valve 20 opens during the ready to load and loaded phases, as shown in FIG. 5.

During the ignition and post-ignition phases, the starting fuel injectors 8 operate in the high-pressure atomisation mode. Upon attaining the ready to load phase, the main solenoid valve 20 opens, thereby supplying fuel directly to the main fuel injectors 20 by way of the main solenoid output line 22, and under such conditions the starting fuel injectors 8 and the main fuel injectors 12 operate with equal pressure, thereby providing sufficient fuel flow to all the starting fuel injectors 8 and the main fuel injectors 12 to prevent injector coking under all conditions. Under low fuel flow conditions, both the starting fuel injectors 8 and the main fuel injectors 12 operate in the air blast mode. With higher fuel flow, such as during the high altitude loaded phase, the starting fuel injectors 8 and the main fuel injectors 20 operate in an air assist mode due to greater available fuel pressure. The air assist mode uses pressurised air to assist in the control of the spray pattern of atomised fuel that flows through the starting fuel injectors 8 and the main fuel injectors 20.

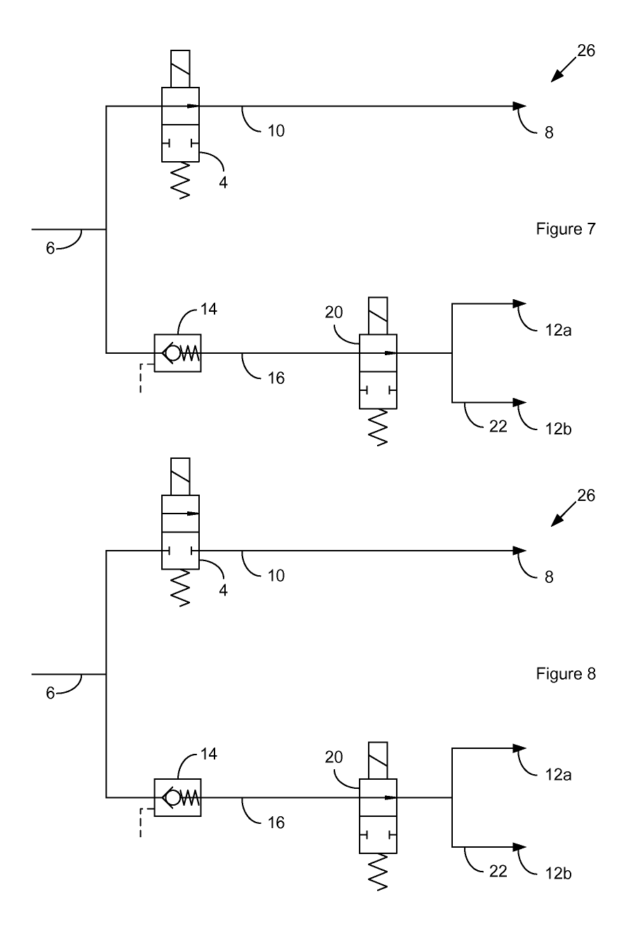

FIGS. 6, 7 and 8 are schematic diagrams of a fuel system 26 for a gas turbine engine according to another possible embodiment of the invention. The start solenoid valve 4 opens for the ignition and post-ignition phases and shuts for the ready to load and loaded phases. FIG. 6 shows the fuel system 26 during the ignition phase with the starting solenoid valve 4 open and the main solenoid valve 20 shut. FIG. 7 shows the fuel system 26 during the post-ignition phase with both the starting solenoid 4 and the main solenoid valve 20 open. FIG. 8 shows the fuel system 26 during the ready to load and loaded phases with the start solenoid valve 4 shut and the main solenoid valve 20 open. During the ignition and post-ignition phases, the starting fuel injectors 8 operate in the high-pressure atomisation mode. During the ready to load phase, the starting fuel injectors 8 shut off and the main fuel injectors 20 operate in the air blast mode. During the loaded phase, the starting fuel injectors 8 remain shut off and the main fuel injectors 20 operate in the air assist mode due to greater available fuel pressure. Shutting off the starting fuel injectors 8 during running conditions maintains higher fuel pressure at higher altitude conditions when fuel flow is low and prevents the simplex main fuel injectors from suffering injector coking.

The described embodiments of the invention are only some illustrative implementations of the invention wherein changes and substitutions of the various parts and arrangement thereof are within the scope of the invention as set forth in the attached claims.

The claimed invention is:

1. A fuel system for a gas turbine engine, comprising:
a set of starting fuel injectors that operate in a fuel pressurised atomisation mode to atomise fuel that flows therethrough during an ignition phase and a post-ignition phase; and
a set of main fuel injectors that operate in an air blast mode to atomise fuel that flows therethrough during the post-ignition phase and a high altitude ready to load phase and an air assist mode to control the pattern of fuel atomisation during a loaded phase.

2. The fuel system of claim 1, further comprising: a starting solenoid valve that opens to direct flow of fuel to the starting fuel injectors during the ignition and post-ignition phases; and
a main solenoid valve that opens to direct flow of fuel to the main fuel injectors during the ready to load and loaded phases.

3. The fuel system of claim 2, further comprising a flow divider that diverts fuel from the starting fuel injectors to the main fuel injectors during the post-ignition phase.

4. The fuel system of claim 1, wherein the main solenoid valve supplies fuel directly to the main fuel injectors during the ready to load and loaded phases.

5. The fuel system of claim 3, wherein the main solenoid valve supplies fuel through the flow divider to the main fuel injectors during the post-ignition, ready to load and loaded phases.

6. The fuel system of claim 5, wherein the main solenoid valve remains shut during the ignition phase.

7. The fuel system of claim 5, wherein the starting solenoid valve shuts during the ready to load and loaded phases.

8. The fuel system of claim 4, wherein the starting solenoid valve remains open during the ready to load and loaded phases.

9. The fuel system of claim 1, wherein the starting fuel injectors are duplex primaries of duplex fuel injectors and the main fuel injectors are a mix of duplex secondaries of duplex fuel injectors and simplex fuel injectors.

10. The fuel system of claim 1, wherein the starting fuel injectors are duplex primaries of duplex fuel injectors and the main fuel injectors are duplex secondaries of duplex fuel injectors.

11. A fuel system for a gas turbine engine, comprising:
a set of starting fuel injectors that operate in a fuel pressurised atomisation mode to atomise fuel that flows therethrough during an ignition and a post-ignition phase;
a set of main fuel injectors that operate in an air blast mode to atomise fuel that flows therethrough during the post-ignition phase and a high altitude ready to load phase and an air assist mode to control the pattern of fuel atomisation during a loaded phase;
a starting solenoid valve that opens to direct flow of fuel to the starting fuel injectors during the ignition and post-ignition phases; and
a main solenoid valve that opens to direct flow of fuel to the main fuel injectors during the ready to load and loaded phases;
wherein the main solenoid valve supplies fuel directly to the main fuel injectors during the ready to load and loaded phases and the starting solenoid valve remains open during the ready to load and loaded phases.

12. The fuel system of claim 11, further comprising a flow divider that diverts fuel from the starting solenoid valve to the main fuel injectors during the post-ignition phase.

13. The fuel system of claim 12, wherein the flow of fuel through the main solenoid valve bypasses the starting solenoid and the flow divider during the ready to load and loaded phases.

14. The fuel system of claim 11, wherein the starting fuel injectors are duplex primaries of duplex fuel injectors and the main fuel injectors are a mix of duplex secondaries of duplex fuel injectors and simplex fuel injectors.

15. The fuel system of claim 11, wherein the starting fuel injectors are duplex primaries of duplex fuel injectors and the main fuel injectors are duplex secondaries of duplex fuel injectors.

16. A fuel system for a gas turbine engine, comprising:
a set of starting fuel injectors that operate in a fuel pressurised atomisation mode to atomise fuel that flows therethrough during an ignition and a post-ignition phase;
a set of main fuel injectors that operate in an air blast mode to atomise fuel that flows therethrough during the post-ignition phase and a high altitude ready to load phase and an air assist mode to control the pattern of fuel atomisation during a loaded phase;
a starting solenoid valve that opens to direct flow of fuel to the starting fuel injectors during the ignition and post-ignition phases;
a main solenoid valve that opens to direct flow of fuel to the main fuel injectors during the ready to load and loaded phases; and
a flow divider that diverts fuel from the starting fuel injectors to the main fuel injectors during the post-ignition phase;
wherein the main solenoid valve supplies fuel through the flow divider to the main fuel injectors during the ready to load and loaded phases and the starting solenoid valve shuts during the ready to load and loaded phases.

17. The fuel system of claim 16, wherein the main solenoid valve remains shut during the ignition phase.

18. The fuel system of claim 16, wherein the starting fuel injectors are duplex primaries of duplex fuel injectors and the main fuel injectors are a mix of duplex secondaries of duplex fuel injectors and simplex fuel injectors.

19. The fuel system of claim 16, wherein the starting fuel injectors are duplex primaries of duplex fuel injectors and the main fuel injectors are duplex secondaries of duplex fuel injectors.
